(19) United States
(12) Patent Application Publication
(10) Pub. No.: US 2008/0272594 A1
(43) Pub. Date: Nov. 6, 2008

(54) Slip type pipe joint

(76) Inventor: Guy Malcolm Phillipps, Eastwood (AU)

Correspondence Address: Olson & Cepuritis, LTD., 20 NORTH WACKER DRIVE, 36TH FLOOR, CHICAGO, IL, 60606, US

(21) Appl. No.: 12/148,229

(22) Filed: Apr. 17, 2008

(30) Foreign Application Priority Data
Oct. 19, 2005 (AU) 2005905769
Oct. 19, 2006 (AU) PCT/AU2006/001547

(51) Int. Cl. F16L 25/00

(52) U.S. Cl. 285/328

(57) ABSTRACT

A slip type pipe fitting for joining two spaced apart plastic pipe ends is disclosed. The fitting includes: a first insert 12 having an elongate pipe support portion 14, insertable into an internal bore of a first plastic pipe end 11, and a distal end 16 in use projecting outside the first pipe end 11 and having a first annular seal 17; an elongate hollow pipe connector 30 defining a bore 32 and having first and second connector ends 40, 50, the inner bore 32 receiving the distal end 16 and first annular seal 17 of the first insert 12 for sliding movement and sealing therein; and a first compression joining assembly including a first end nut 42 for mechanically joining the first connector end 40 to the first pipe end 11 by a compression action sandwiching the first pipe end 11 between the first end annular member 42 and the pipe support portion 14 thereby locking the connector 30 with respect to the first pipe end 11. In use the support portion 14 extends into the first pipe end 11 an axial distance AL such that said locking can occur over a range of axial positions.

### FIELD OF THE INVENTION

The present invention relates to pipe joining, repair and pipe take-off methods and pipe fittings therefor. The invention relates in particular to methods and pipe fittings suitable for sealably joining spaced-apart axially aligned pipe ends in above and below ground applications.

### BACKGROUND

Low cost irrigation pipes or “rural pipes” are commonly made with nominal diameters of ½, ¾, 1, 1¼, 1½ and 2 inches in polyethylene plastic. Such pipes are typically thin walled and joined by mechanical compression fittings. Generally, thin walled pipes are imperial sized and require a barbed insert or liner to act as a stiffener to prevent the pipe wall from collapsing under compression and to provide a tail or spigot having a specific sized outer diameter for insertion into the fitting. In some cases both imperial and metric sized pipes require a barbed insert or liner depending on their pressure rating.

Compression fittings or mechanical couplings for Australian Rural pipe (formally Class B imperial polyethylene pipe), whether they be straight joiners, tees, elbows or threaded end connectors typically comprise a central body, an insert (liner), collapsible gripper ring, a nut and a seal ring. The seal ring can either be attached to the insert or housed within the body of the main fitting. Alternatively, some fittings have the insert attached to the main body and a threaded nut that winds back over the pipe, or some external clamping mechanism, collapsing the pipe wall onto the insert to form a watertight seal.

The most common fitting to pipe assembly process requires a pipe to be cut to the required length. A nut is then passed over the outside of the pipe followed by a gripper ring prior to pushing an insert or liner into the bore of the pipe. The insert or liner is then pushed into the fitting body up to a predetermined stop. A seal is created between the insert and fitting body by deformation of a seal. The nut is tightened forcing the gripping member to bite into the pipe, thereby compressing the wall of the pipe onto an insert with raised barbs on the outside surface of the insert forming a watertight seal between the inside wall of the pipe and the outside of the insert.

In most applications, the pipe is buried in a trench below the surface of the ground. The fittings are usually installed prior to the trench being filled in. In this situation, there is usually adequate room to flex the pipe so as to adjust the path of the pipe and to manipulate the pipe end making assembly relatively easy and quick. Thus, mechanical compression fittings have become commonly used for the construction and repair of rural irrigation pipes. Difficulties do arise, however, when the pipes are later coupled together and contraction of the pipe has occurred or when inserting the inserts (liners) as this operation can cause the pipes to move axially away from themselves, resulting in the fitting being too short. Difficulties also arise when making repairs and modifications to existing rural piping systems, particularly where the piping is buried and the ground has become extremely hard to penetrate.

Should a take-off be required, should insertion of an isolating valve be required or should the pipe form a leak, it is necessary to dig down to the pipe to expose the leak or area where the modification is required. To make a joint it is necessary to dig the pipe back some distance to enable sufficient flex in the pipe to manipulate the pipe end to push the tail of the insert (the spigot) into the body of the fitting to form a seal. In many instances in repair situations the repair may require two fittings and a piece of pipe to fix the damaged pipe. The pipe can also contract when the pipe is cut making the gap too long for a standard single coupling or joiner to be used.

The process of digging to clear around a significant length of pipe either side of the area to be repaired, or the area in which a modification is required, is time consuming and costly. Care must be taken to ensure the pipe is not further damaged in the process.

A further problem with existing techniques is that generally the user must allow time for glued joints to cure before the pipe can be pressurised.

A still further problem with existing techniques is that a clean and dry environment is required to achieve reliable mechanical and/or sealed joints. For example, existing techniques make repair difficult in a submerged environment or an environment where flow and hence pressure from the pipe to be repaired or modified cannot be isolated.

It is an object of the present invention to overcome at least some of the above problems.

It is a further object of the invention to provide a slip type pipe joint and components therefor that provides sealed communication across a gap between two spaced apart axial line pipes without the need to move either of the pipe ends axially any further than a few degrees and with considerable tolerance in the cutting of the pipe space.

It is a further object of the invention to provide a slip type pipe joint that provides sealed communication across a gap between two spaced apart axial line pipes without curing time being required before pressurisation.

It is a still further object of the invention to provide a slip type pipe joint with a small number of components, at least some of which are interchangeable with other pipe fittings and pipe standards.

It is a yet still further object of the invention to provide a slip type joint which does not rely on a seal being formed between a sealing member and the outside diameter of a pipe.

### SUMMARY OF THE INVENTION

In one aspect, the invention is a slip type pipe fitting for joining two spaced apart plastic pipe ends, the fitting including:
a first insert having an elongate pipe support portion, insertable into an internal bore of a first plastic pipe end, and a distal end in use projecting outside the first pipe end, the distal end having a first annular seal;
an elongate hollow pipe connector defining an inner bore and having first and second connector ends, the inner bore receiving the distal end and first annular seal of the first insert for sliding movement and sealing therein;
a first compression joining assembly including a first end annular member for mechanically joining the first connector end to the first pipe end by a compression action sandwiching the first pipe end between the first end annular member and the elongate pipe support portion thereby locking the connector with respect to the first pipe end;
a second insert having a pipe support portion, insertable into a second plastic pipe end, and a distal end outside the second pipe end; and
a second joining assembly for mechanically joining the second connector end to the second pipe end,
wherein in use the elongate support portion extends into the first pipe end an axial distance such that said sandwiching and locking can occur over a range of axial positions, the range having a length measured axially exceeding fifty percent of an outside diameter of the first pipe end.

A specific embodiment of the invention will now be described in some further detail with reference to and as illustrated in the accompanying figures. This embodiment is illustrative, and is not meant to be restrictive of the scope of the invention.

### DETAILED DESCRIPTION OF A PREFERRED EMBODIMENT OF THE INVENTION

A preferred embodiment of the invention is illustrated in the accompanying representations in which:

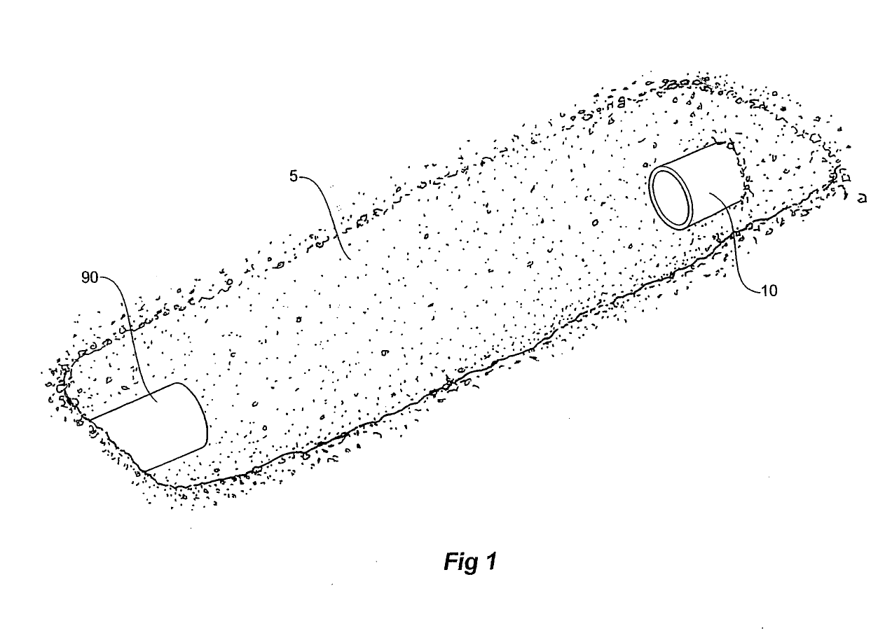

FIG. 1 shows a trench exposing pipe ends ready to be joined by a pipe fitting.

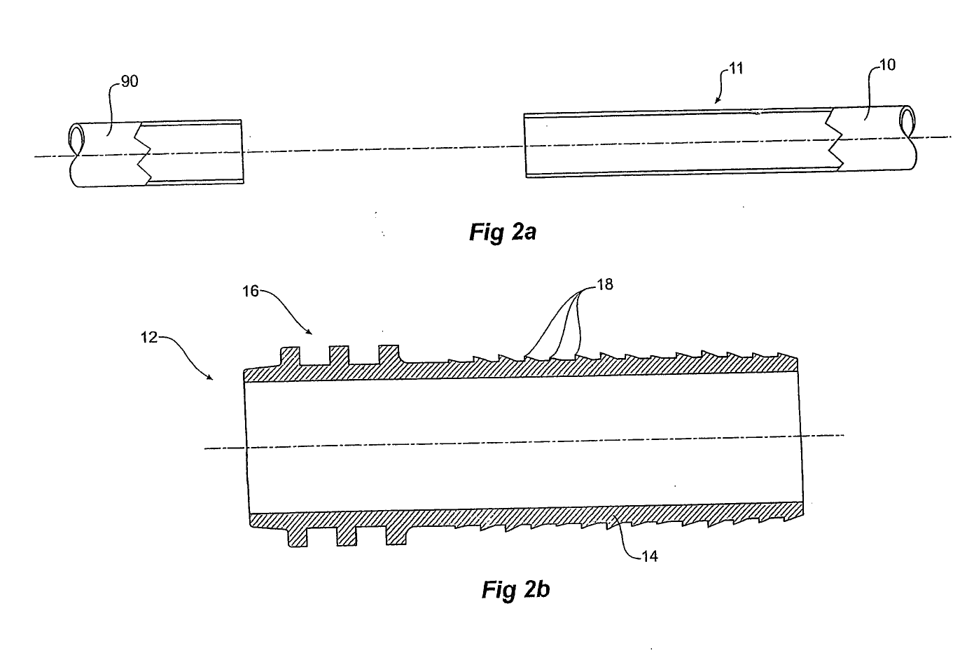

FIG. 2a shows the pipe ends of FIG. 1 in a cutaway cross-sectional view.

FIG. 2b shows a cross-sectional view of a first insert for insertion into a pipe end.

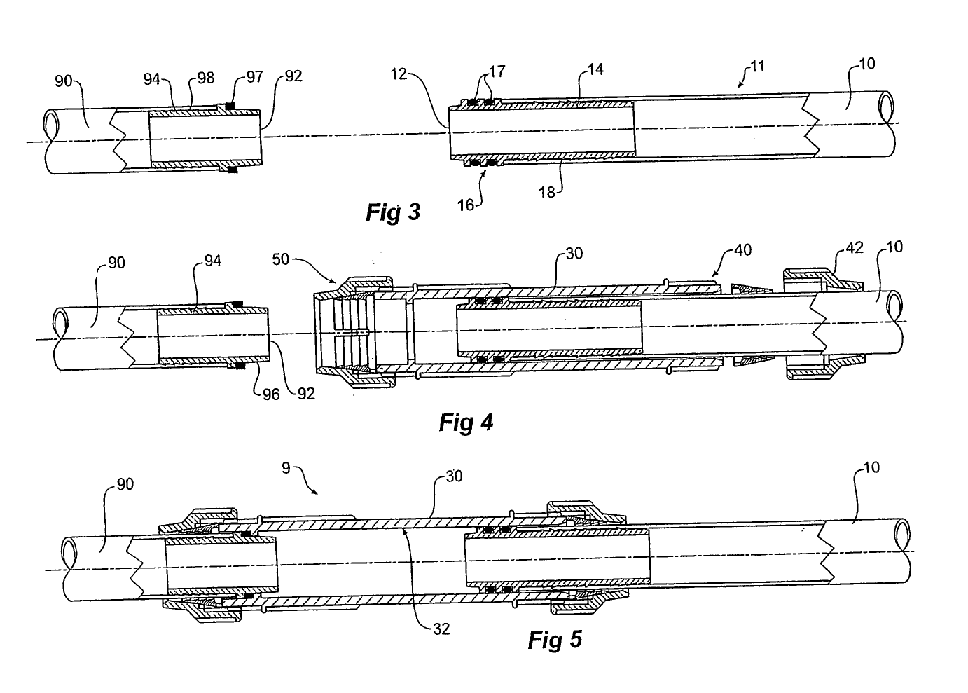

FIG. 3 shows the first insert of FIG. 2b and a second insert inserted into the pipe ends of FIG. 1 and FIG. 2a.

FIGS. 4 and 5 show a slip type pipe joint according to the invention in progressive stages of assembly.

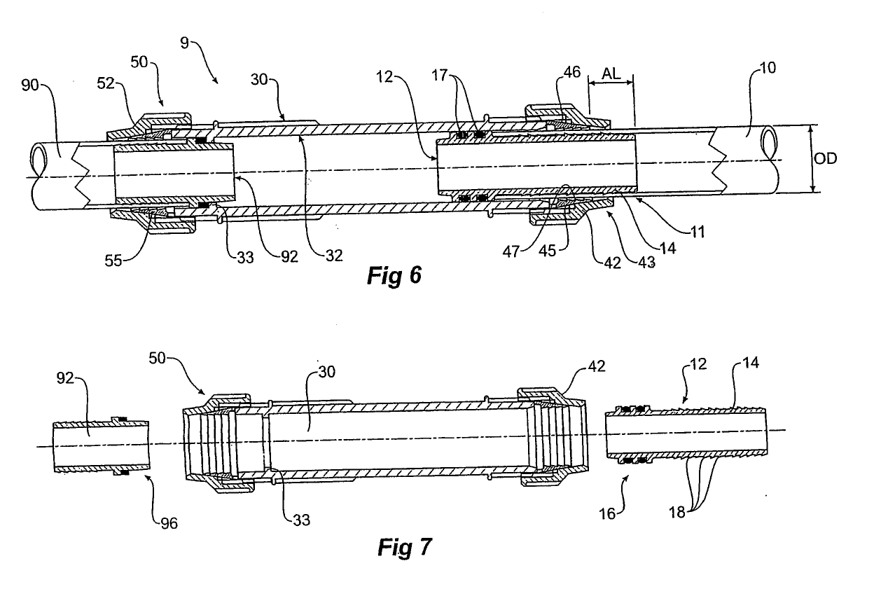

FIG. 6 is an enlarged view of the slip type pipe joint of FIG. 5.

FIG. 7 is a cross-sectional view showing the components of the slip type pipe joint of FIG. 6.

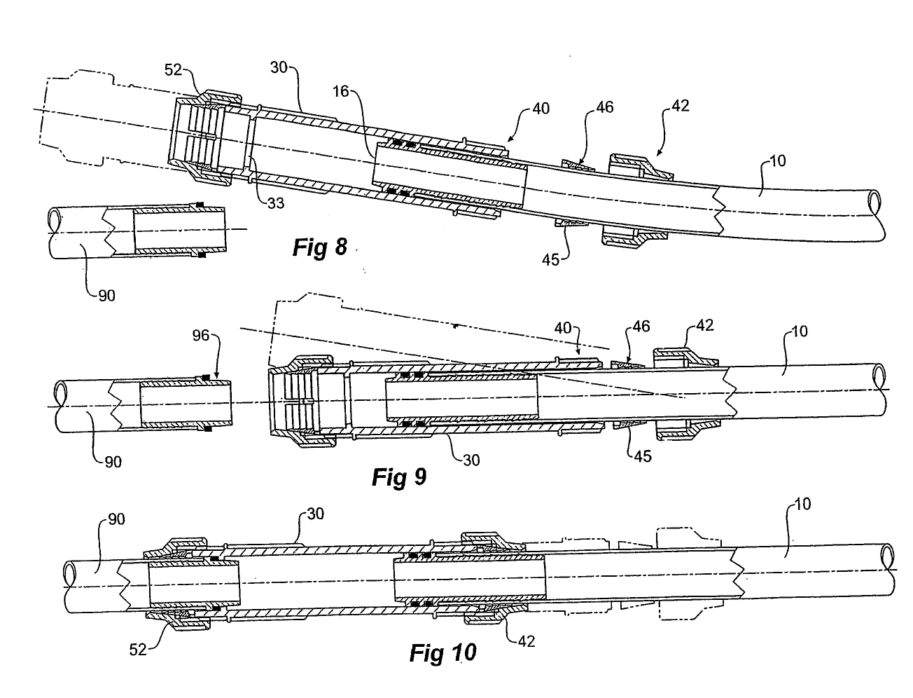

FIGS. 8, 9 and 10 show the slip type pipe joint of FIG. 6 at progressive stages of assembly; while

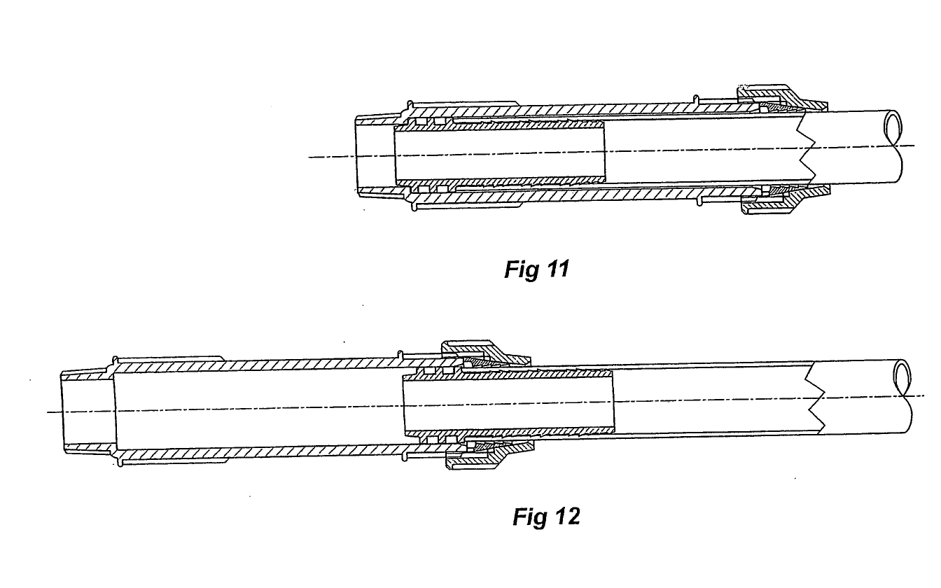

FIGS. 11 and 12 show an alternative embodiment of the invention.

Referring to FIGS. 1 and 2a, two spaced apart polymeric pipe ends are shown. A first insert 12 having elongate pipe support portion 14 is shown in FIG. 2b. The elongate pipe support portion 14 is inserted within the first pipe end 10 as is shown in FIG. 3. A distal end 16 of the first insert 12 is outside the first pipe end 10. This distal end 16 has a pair of first annular seals 17. While only one seal is required, two seals provide additional integrity.

Now referring to FIGS. 4, 5 and 6, it can be seen that the slip type pipe joint 9 includes an elongate hollow pipe connector 30 which defines an inner bore 32 and has first and second connector ends 40 and 50. A first compression joining assembly for mechanically joining the first connector end 40 to the first pipe end 10 comprises a first end annular member in the form of a nut 42 and a first wedging ring 45 most clearly shown in FIG. 6. The first end nut 42, which is threadably mounted to the first connector end 40, has an internally tapered end 43 as is shown most clearly in FIG. 6. The first end wedging ring 45 has a tapered external surface 46 and a barbed internal surface 47 for gripping the outside of the first pipe end 10. Tightening of the first end nut 42 causes a wedging compression action sandwiching the first pipe end 10 between the first end wedging ring 45 and the elongate pipe support portion 14 of the first insert 12, thereby locking the connector 30 with respect to the first pipe end 10.

In use, the elongate support portion 14 at the first insert 12 extends into the first pipe end 10 an axial distance such that the sandwiching and locking referred to above, can occur over a range of axial positions. The range has a length measured axially as illustrated by arrow AL in FIG. 6. The length AL exceeds 50% of an outside diameter of the first pipe end 10 illustrated by arrow OD also in FIG. 6. In fact, the length AL exceeds 90% of an outside diameter of the first pipe end 10 illustrated by arrow OD in FIG. 6 for the preferred embodiment of the invention.

The pipe joint shown in FIG. 6 constructed from the parts shown in FIG. 7 is able to accommodate a range of spacings between the pipe ends shown in FIG. 2a. Specifically, a range of the length AL can be accommodated. In practice, this is a great advantage as it is difficult to exactly cut pipe ends to fit particular fitting lengths. The fitting shown in FIGS. 6 and 7 allows for easy repair to a pipe buried in the ground, such as the pipe of FIG. 1, with minimal parts required.

The connector 30 has a second joining assembly for mechanically joining the second connector end 50 to the second pipe end 90. This second joining means comprises a second end nut 52 and a second end wedging ring 55 as is most clearly shown in FIG. 6.

The above described second joining assembly operates in a similar way to the above described first joining assembly, sandwiching the second pipe end 90 between the second end wedging ring 55 and the pipe support portion 94 of the second insert 92.

Referring to FIGS. 3 and 7 it can be seen that insert 92 is a conventional insert, whereas insert 12 is a new insert providing an elongate pipe support portion 14 provided to allow the above described slip type adjustment over the range AL.

With both the first and second inserts 12 and 92, annular barbs 18 and 98 respectively are provided for engaging inner surfaces of the first and second pipe ends 10 and 90 respectively to create a seal (most clearly shown in FIGS. 2b and 3 respectively).

A pair of first annular seals in the form of “O” rings 17 is provided to affect a seal between the connector 30 and its inner bore 32. While in this embodiment of the invention a pair of annular O-ring seals is used, other sealing arrangements may be used. For instance, the seal or seals may be integral to the distal end rather than being separable.

The connector 30 is of a slip type nature and is movable with respect to the first insert 12 so as to facilitate repair between first and second pipe ends 10 and 90, such as those shown in FIG. 1, without the need to move the pipe ends 10 and 90 axially. In contrast, with prior art techniques significant excavation involving breaking up of asphalt and/or concrete is often required to allow the pipe ends to be manipulated so as to achieve the axial movement necessary to position them within fitting ends.

FIG. 1 shows the pipe ends 10 and 90 exposed within a trench in the ground 5. Installation of the components of the pipe joint 9 between the two spaced apart axially aligned pipe ends 10 and 90 is progressively shown in FIGS. 3 to 5.

The inserts 12 and 92 perform two functions. Firstly, the wall thickness of a typical plastics imperial pipe is inadequate to allow effective clamping by the wedging rings 45 and 55. The inserts stiffen the pipe ends 10 and 90. By changing the size of the insert barbed end, different pipes of different standards and mediums can also be adapted. Secondly the inserts provide a tail or spigot end with an outer diameter that fits the correctly sized sealing chamber within the bore of the fitting.

With other embodiments of the invention (not shown), the connector 30 may include a take-off. With such embodiments, the take-off can be orientated at right angles. Various angles may be used to create “T” joints, “Y” joints or other arrangements.

With further embodiments of the invention, not shown, isolation valves or other piping elements may be incorporated or connected into the connector 30 whereas an example, one of the male threaded ends, i.e. end connector 50 could be replaced with various male or female sealing threads as opposed to the specific thread designed to suit the nut 52. One such example is shown in FIG. 11.

A method, according to a second aspect of the invention, of providing sealed communication across a gap between two spaced apart axial aligned pipe ends without the need to significantly move either of the pipe ends will now be described. With this method it is not necessary to move the pipe ends axially or longitudinally.

Typically, rural pipe will be buried below ground and the first step in repairing a leak in the underground pipe or inserting a take-off or isolation valve using this method is to dig around the area of the leak or the area in which the modification is required to expose the pipe. FIG. 1 shows such an excavation. In FIG. 1 it can be seen that the pipe ends 10 and 90 have been cut cleanly. It is then possible to insert a first elongate barbed pipe support end 14 of a first insert 12 into a first of the two pipe ends 10 as is shown in FIG. 3. The first insert 12 has a first spigot end 16 supporting a first pair of annular seals 17. A second barbed pipe support portion 94 of a second insert 92 can be inserted into a second of the two pipe ends 90 in a similar way. A slip type pipe connector 30, such as the fitting shown in FIG. 3 can then be inserted between the insert/spigot ends 12 and 92 in stages as is shown in FIGS. 8 to 10.

Referring to FIG. 8, the first connector end 40 is slid over the first insert (spigot) distal end 16 while the pipe end 10 is bent. The nut 42 and wedging ring 45 can be removed and slid onto the pipe end 10 separately prior to sliding the connector end 40 over the first insert 12. However both ends of the connector 30 can be located onto respective ends of the pipe 10 and 90 with the nuts 42 and 52 and wedging ring 45 and 55 loosely fitted to the connector 30.

Next the connector 30 can be slid down along the pipe toward or up to the stop 33 and then bent back into its original position. The second connector end 50 slides over the second connector end 96 as is shown in FIGS. 9 and 10.

With the installation method described above, a seal is affected as the fitting ends slide over the spigot ends prior to the nuts 42 and 52 being tightened. This provides an immediate seal, thereby providing sealed communication across the gap between the two spaced apart pipe ends, 10 and 90, without the need to move either of the pipe ends, 10 and 90 to any great extent or in a longitudinal direction (or include any additional pipe pieces).

With the method described above, exact cutting of the pipe ends 10 and 90 shown in FIGS. 1 and 2a is not necessary. The telescopic nature of the connector 30 which allows sealing and locking over an axial range AL illustrated in FIG. 6 allows joining of pipe ends without the need for exact spacing between the pipe ends.

With the embodiments of the invention described above, a seal is formed between insert 12 and the inner bore 32 of the connector 30 and between insert 92 and the inner bore 32 of connector 30. A seal is formed by O-ring seals. This contrasts to other fittings which rely on a seal being formed between an O-ring and the outer diameter of a pipe. Such arrangements can be unreliable given that the outer surface of a pipe can easily be scored or otherwise damaged, creating possible leakage paths between the outer diameter of the pipe and any seal. Scoring can occur during expansion and contraction of a pipe while it is in the ground. Therefore, the fact that the embodiments of the invention described above are unaffected by such scoring provides an important advantage.

Before back-filling the trench, the connector 30 is locked with respect to the first pipe end 10 by tightening nut 42 (for instance in the position shown in FIG. 10). The connector 30 is locked with respect to the second pipe end 90, by tightening nut 52 before the trench is back-filled.

While the present invention has been described in terms of a preferred embodiment in order to facilitate better understanding of the invention, it should be appreciated that various modifications can be made without departing from the principles of the invention. Therefore, the invention should be understood to include all such modifications within its scope.

1. A slip type pipe fitting for joining two spaced apart plastic pipe ends, the fitting including:
a first insert having an elongate pipe support portion, insertable into an internal bore of a first plastic pipe end, and a distal end in use projecting outside the first pipe end, the distal end having a first annular seal;
an elongate hollow pipe connector defining an inner bore and having first and second connector ends, the inner bore receiving the distal end and first annular seal of the first insert for sliding movement and sealing therein;
a first compression joining assembly including a first end annular member for mechanically joining the first connector end to the first pipe end by a compression action sandwiching the first pipe end between the first end annular member and the elongate pipe support portion thereby locking the connector with respect to the first pipe end;
a second insert having a pipe support portion, insertable into a second plastic pipe end, and a distal end outside the second pipe end; and
a second joining assembly for mechanically joining the second connector end to the second pipe end,
wherein in use the elongate support portion extends into the first pipe end an axial distance such that said sandwiching and locking can occur over a range of axial positions, the range having a length measured axially exceeding fifty percent of an outside diameter of the first pipe end.

2. A slip type pipe fitting as claimed in claim 1, the range having a length measured axially exceeding eighty percent of an outside diameter of the first pipe end.

3. A slip type pipe fitting as claimed in claim 2, the range having a length measured axially exceeding one hundred percent of an outside diameter of the first pipe end.

4. A slip type pipe fitting as claimed in claim 1 wherein the elongate pipe support portion of the a first insert defines at least one annular barb for sealing engagement with the internal bore of first plastic pipe end.

5. A slip type pipe fitting as claimed in claim 4 wherein the first end annular member comprises a first end nut threadably mounted to the first connector end, the first end nut having an internally tapered end.

6. A slip type pipe fitting as claimed in claim 5 wherein the first compression joining assembly comprises:
a first end wedging ring having a tapered external surface co-operable with the internally tapered end of the first end nut and a barbed internal surface for gripping the outside of the first pipe end, tightening of the first end nut causing a wedging action sandwiching the first pipe end between the first end wedging ring and the elongate pipe support portion thereby locking the connector with respect to the first pipe end.

7. A slip type pipe fitting as claimed in claim 6 wherein the elongate pipe support portion of the first insert has a pair of annular seals.

8. A slip type pipe fitting and plastic pipe assembly including:
a first plastic pipe end;
a first insert having an elongate pipe support portion, insertable into an internal bore of the first plastic pipe end, and a distal end in use projecting outside the first pipe end, the distal end having a first annular seal;
an elongate hollow pipe connector defining an inner bore and having first and second connector ends, the inner bore receiving the distal end and first annular seal of the first insert for sliding movement and sealing therein;
a first compression joining assembly including a first end annular member for mechanically joining the first connector end to the first pipe end by a compression action sandwiching the first pipe end between the first end annular member and the elongate pipe support portion thereby locking the connector with respect to the first pipe end;
a second plastic pipe end;
a second insert having a pipe support portion, insertable into the second plastic pipe end, and a distal end outside the second pipe end; and
a second joining assembly for mechanically joining the second connector end to the second pipe end,
wherein in use the elongate support portion extends into the first pipe end an axial distance such that said sandwiching and locking can occur over a range of axial positions, the range having a length measured axially exceeding fifty percent of an outside diameter of the first pipe end.

9. An assembly as claimed in claim 8, the range having a length measured axially exceeding eighty percent of an outside diameter of the first pipe end.

10. An assembly as claimed in claim 9, the range having a length measured axially exceeding one hundred percent of an outside diameter of the first pipe end.

11. An assembly as claimed in claim 8 wherein the elongate pipe support portion of the first insert defines at least one annular barb for sealing engagement with the internal bore of first plastic pipe end.

12. An assembly as claimed in claim 11 wherein the first end annular member comprises a first end nut threadably mounted to the first connector end, the first end nut having an internally tapered end.

13. An assembly as claimed in claim 12 wherein the first compression joining assembly comprises:
a first end wedging ring having a tapered external surface co-operable with the internally tapered end of the first end nut and a barbed internal surface for gripping the outside of the first pipe end, tightening of the first end nut causing a wedging action sandwiching the first pipe end between the first end wedging ring and the elongate pipe support portion thereby locking the connector with respect to the first pipe end.

14. An assembly as claimed in claim 13 wherein the elongate pipe support portion of the first insert has a pair of annular seals.

15. A slip type pipe fitting for joining two spaced apart plastic pipe ends, the fitting including:
a first insert having an elongate pipe support portion, insertable into an internal bore of a first plastic pipe end, and a distal end in use projecting outside the first pipe end, the distal end having a first annular seal;
an elongate hollow pipe connector defining an inner bore and having first and second connector ends, the inner bore receiving the distal end and first annular seal of the first insert for sliding movement and sealing therein; and
a first compression joining assembly including a first end annular member for mechanically joining the first connector end to the first pipe end by a compression action sandwiching the first pipe end between the first end annular member and the elongate pipe support portion thereby locking the connector with respect to the first pipe end,
wherein in use the elongate support portion extends into the first pipe end an axial distance such that said sandwiching and locking can occur over a range of axial positions, the range having a length measured axially exceeding fifty percent of an outside diameter of the first pipe end.

16. A slip type pipe fitting as claimed in claim 16, the range having a length measured axially exceeding eighty percent of an outside diameter of the first pipe end.

17. A slip type pipe fitting as claimed in claim 17, the range having a length measured axially exceeding one hundred percent of an outside diameter of the first pipe end.

18. A slip type pipe fitting as claimed in claim 16 wherein the elongate pipe support portion of the a first insert defines at least one annular barb for sealing engagement with the internal bore of first plastic pipe end.

19. A slip type pipe fitting as claimed in claim 19 wherein the first end annular member comprises a first end nut threadably mounted to the first connector end, the first end nut having an internally tapered end.

20. A slip type pipe fitting as claimed in claim 20 wherein the first compression joining assembly comprises:
a first end wedging ring having a tapered external surface co-operable with the internally tapered end of the first end nut and a barbed internal surface for gripping the outside of the first pipe end, tightening of the first end nut causing a wedging action sandwiching the first pipe end between the first end wedging ring and the elongate pipe support portion thereby locking the connector with respect to the first pipe end.

21. A slip type pipe fitting as claimed in claim 21 wherein the elongate pipe support portion of the first insert has a pair of annular seals

22. A slip type pipe fitting and plastic pipe assembly including:
a first plastic pipe end;
a first insert having an elongate pipe support portion, insertable into an internal bore of the first plastic pipe end, and a distal end in use projecting outside the first pipe end, the distal end having a first annular seal;
an elongate hollow pipe connector defining an inner bore and having first and second connector ends, the inner bore receiving the distal end and first annular seal of the first insert for sliding movement and sealing therein; and
a first compression joining assembly including a first end nut threadably mounted to the first connector end, the first end nut having an internally tapered end, a first end wedging ring having a tapered external surface co-operable with the internally tapered end of the first end nut and a barbed internal surface for gripping the outside of the first pipe end, tightening of the first end nut causing a wedging action sandwiching the first pipe end between the first end wedging ring and the elongate pipe support portion thereby locking the connector with respect to the first pipe end.
a second plastic pipe end;
a second insert having a pipe support portion, insertable into the second plastic pipe end, and a distal end outside the second pipe end; and
a second joining assembly for mechanically joining the second connector end to the second pipe end,
wherein in use the elongate support portion extends into the first pipe end an axial distance such that said sandwiching and locking can occur over a range of axial positions, the range having a length measured axially exceeding eighty percent of an outside diameter of the first pipe end.
